(19) United States
(12) Patent Application Publication
(10) Pub. No.: US 2014/0225740 A1
(43) Pub. Date: Aug. 14, 2014

(54) SYSTEM AND DEVICES TO MAINTAIN PHYSICAL OBJECTS CONNECTED TO ONE ANOTHER

(71) Applicant: Rachel Hochman, Tarzana, CA (US)

(72) Inventor: Rachel Hochman, Tarzana, CA (US)

(21) Appl. No.: 13/767,282

(22) Filed: Feb. 14, 2013

(51) Int. Cl. G08B 21/18

(52) U.S. Cl. CPC G08B 21/18
USPC 340/686.6

(57) ABSTRACT

A system configured to maintain physical objects connected to one other. The system includes a set of paired electronic devices to be affixed to a pair of first and second objects of a user that are to be maintained substantially connected thereto. A first electronic device is affixed to a first object and a second electronic device of the paired set is affixed to the second object. A separation parameter distance threshold is set in each of the paired electronic devices. An audio message is emitted from each paired device of the set if the separation parameter distance threshold is exceeded, and deactivated upon a separation distance between the objects having decreased below a set reset parameter. The audio message is customizable by the user and configured to be modified from a remote location.

### CROSS-REFERENCE TO RELATED APPLICATION

The present application claims the benefit under 35 U.S.C. §119(e) of U.S. Provisional Patent Application No. 61/598,447 to the inventor, filed Feb. 14, 2012, the entire contents of which is hereby incorporated by reference herein.

### BACKGROUND

1. Field

Example embodiments in general relate to a system and devices to maintain physical objects connected to one another.

2. Related Art

Many devices have been developed to assist in re-locating lost objects such as valuables, pets, and children. Examples includes homing devices to assist a person or caregiver to track a missing child or lost personal object, in which a main or central unit is triggered and a wireless or remote tag on the missing object/person is activated. Other location devices include electronic leashes that alert when people or pets wander off. These locator devices have further been integrated into creative form-factors such as sunglasses or teddy bears.

More complex location systems include network triangulation and GPS interrogation techniques; such systems are designs to pinpoint the location and distance of an object or person from a point of origin. All of these systems and devices are designed to track, prevent and/or recover lost objects, people, animals, and the like.

With the miniaturization electronic components and advances in wireless communication and the internet, humanity has now become virtually connected. What is needed is system and devices to maintain material objects physically connected; whether the object is a person, animal or valuable; a device that connects the physical world together.

### SUMMARY

An example embodiment is directed to a system configured to maintain physical objects connected to one other. The system includes a set of paired electronic devices to be affixed to a pair of first and second objects of a user that are to be maintained substantially connected thereto. A first electronic device is affixed to a first object and a second electronic device of the paired set is affixed to the second object. A separation parameter distance threshold is set in each of the paired electronic devices. An audio message is emitted from each paired device of the set if the separation parameter distance threshold is exceeded, and deactivated upon a separation distance between the objects having decreased below a set reset parameter. The audio message is customizable by the user and configured to be modified from a remote location.

### BRIEF DESCRIPTION OF THE DRAWINGS

Example embodiments will become more fully understood from the detailed description given herein below and the accompanying drawing, wherein like elements are represented by like reference numerals, which are given by way of illustration only and thus are not limitative of the example embodiments herein.

FIG. 1 is a diagram of an action between paired electronic devices upon violation of a separation distance parameter according to an example embodiment.

FIG. 2 illustrates front and rear surfaces of the electronic device in FIG. 1.

FIG. 3 is a diagram to describe various applications of objects and people applicable to the system and devices according to the example embodiments.

FIG. 4 is a diagram of an example customized message emitted between paired electronic devices upon violation of a separation distance parameter according to an example embodiment.

FIG. 5 is a diagram of the example customized message of FIG. 4 emitted between paired electronic devices upon violation of a separation distance parameter between different objects.

FIG. 6 is a diagram of another example customized message emitted between paired electronic devices upon violation of a separation distance parameter according to an example embodiment.

FIG. 7 is a diagram of another example customized message emitted between paired electronic devices upon violation of a separation distance parameter according to an example embodiment.

FIG. 8 is an example screenshot of a website application accessible by a user or potential user of the system.

FIG. 9 is an example screenshot of a webpage of the application upon login by a user.

FIG. 10 is another example screenshot of a webpage of the application upon login by a user.

FIG. 11 is a smart phone with displayed application thereon which interfaces with the system for access by a user, according to an example embodiment.

### DETAILED DESCRIPTION

As to be set forth more fully below, the example embodiments in general are directed to a system and/or paired electronic devices configured to maintain physical objects connected to one other.

The physical world frequently is connected in pairs: keys to wallet, cell phone to purse, parent to child, pet owner to pet, right shoe to left shoe, etc. As to be shown in more detail hereafter, the example embodiments provide a set of paired electronic devices where each device includes transmitter and receiver elements (transceiver) that in an example may be configured to continuously communicate with one other. A user may affix each device to any two physical objects to keep the two objects connected to each other. When the paired physical objects with the affixed electronic devices disconnect from each other and exceed a separation distance parameter threshold, a microprocessor in each device triggers one or more of an audible alarm, a flashing light and a customized recorded, audible message. This notifies the user that the objects are no longer connected. The triggered condition (audible arm, light and/or recorded message) terminates once the paired objects are reconnected (or when a separation distance between the objects has decreased below a set reset parameter).

### Example 1

A user affixes one electronic device to their keys and the other electronic device to their handbag; hence, connecting their keys and handbag. If there is a breach of the separation distance parameter threshold between the handbag and keys, i.e., someone walks off with their handbag or the user walk off leaving their keys, the triggering condition on both electronic devices is met. The paired objects, keys and handbag, must be connected at all times for the triggering condition not to be activated.

### Example 2

This same user could use the same electronic device to connect their handbag and their child. The user would affix one electronic device to their handbag and the other electronic device to their child; hence, connecting their handbag and child. If there is a breach of the separation distance parameter threshold between the handbag and child, the triggering condition on both electronic devices is met. When the child and the handbag are reconnected, the triggering condition deactivates.

Additionally, the example embodiments described hereafter are directed to a system which enables users to customize the electronic devices that they affix to objects. Users may customize their electronic devices by accessing the internet via their computer, cell phone, or tablet. Information may be sent remotely to a microprocessor on the device, via transceiver and associated antenna, to reconfigure the electronic device(s) to the user's needs.

Customization includes the triggering condition and format. The user can change and customize the trigger to be anything the user records. In Example 1, instead of the conventional audio noise alert (such as a high decimal beeping noise), the trigger for breach of the separation distance parameter threshold for the keys and the handbag example could be, “Janice, Janice, did you forget something?”

In Example 2, if that same user decided to connect their handbag and their child together, they could record a new trigger alert for breach of the separation distance parameter threshold. This time when on breach, the device affixed to the child could trigger, “Stop Rachel, you wandered too far from Mommy” or “If you find this child, please call, 555-1212.” Alternately, the device affixed to the handbag could trigger, “Rachel has wandered off” or “Did you lose your child?”

Additionally, the example system provides a web application interface to enable users to record messages for someone else's electronic devices. For example, a child's jacket and backpack could be connected. Their breach of separation distance parameter threshold message could be, “I love you, but did you forget something?” which was recorded by a military parent stationed overseas. The parent could change the recording daily and still be connected, despite the distance. Hence, the triggering alert could be anything custom voice recorded.

Customization may also include the distance set for the separation distance threshold parameter; this is adjustable by the user via the web application interface. In one example, the separation distance threshold parameter may be adjustable in a range from about 1-1000 feet between paired objects.

### Example 3

Accordingly, if the user of Examples 1 and 2 opts to affix the electronic devices to connect their handbag and dog together instead of their handbag and child, they could reduce the separation distance threshold parameter. The electronic device could then become a training tool for the dog; the trigger message could be, “Sparky Come. Sparky Come”.

In another example, the example system may include a central unit. The central unit can either be independent, attached to a cellular phone or integrated into the cellular device via manufacturing and software. The central device is configurable to connect multiple pairs of electronic devices thereto. For example, if a user had four (4) pairs of electronic devices and a central unit, all the electronic devices could be connected to the central unit; the electronic devices being affixed to 8 physical objects. When there is a breach of a separation distance threshold parameter on one of the electronic devices monitored and/or controlled by the central unit, the central unit and the electronic device(s) will trigger the personalized/customized message until the affixed electronic devices are reconnected.

### Example 4

To illustrate the concept, a family of six (6) could be connected using three (3) pairs of electronic devices and a central unit. Each electronic device could be customized and affixed to every family member. If there is a breach of distance between a child and the central unit, both the central unit and the corresponding electronic device would be triggered.

If paired objects do get separated, the system includes a registration feature to enable the return of separated objects. Assuming the user has registered their electronic devices, if a good Samaritan finds one of the paired objects that were separated; they could notify the user by going to the web application on the internet and entering the serial number of the electronic device. The user will then be notified via one or more of email, telephone or text.

In another variant, the example system also includes a pair of electronic devices that instead of being customized remotely by accessing the web, adjustments to these electronic devices are adjusted from the central unit. The user may have the ability to record the triggering message and adjust the separation distance threshold parameter from the central unit instead of being required to access the web-based application via the internet interface.

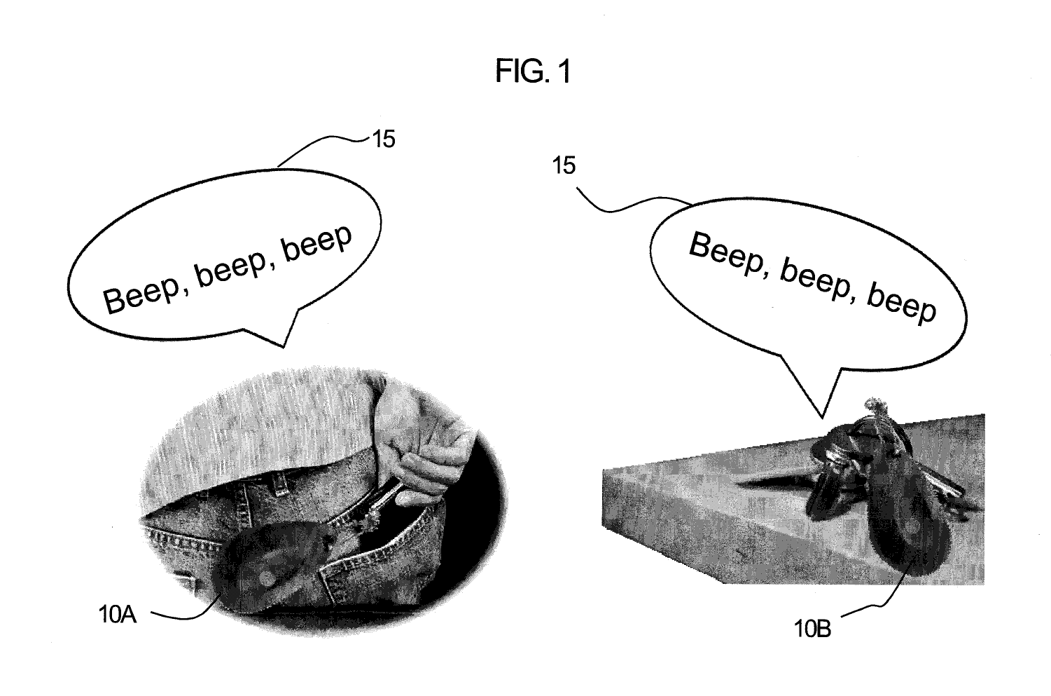

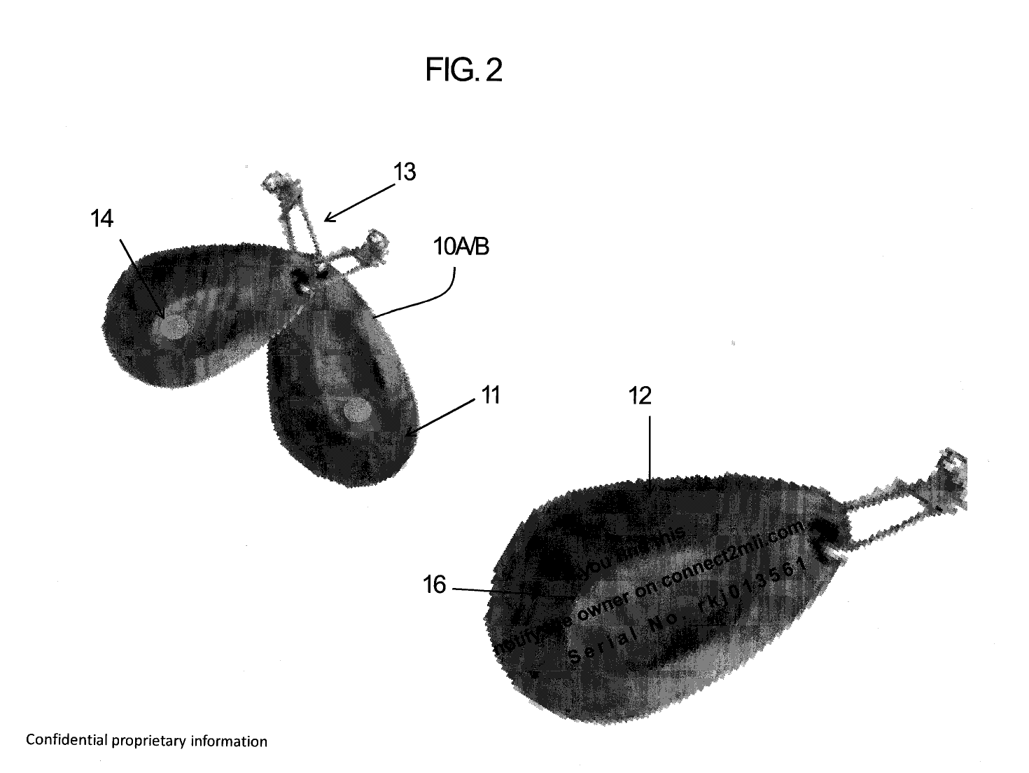

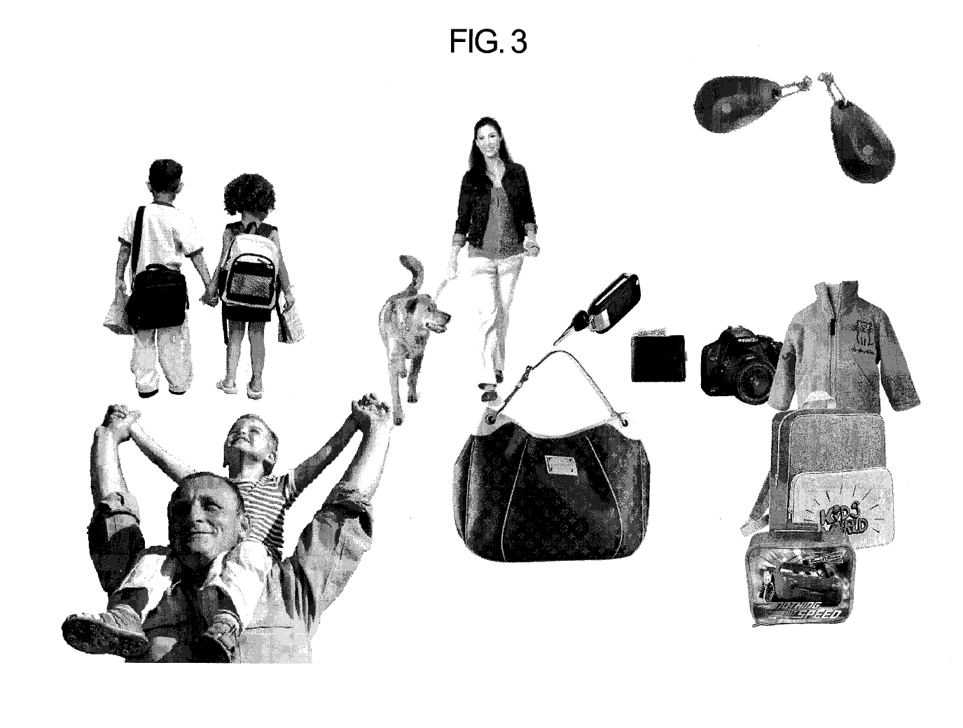

FIG. 1 is a diagram of an action between paired electronic devices upon violation of a separation distance parameter according to an example embodiment; FIG. 2 illustrates front and rear surfaces of the electronic device in FIG. 1, and FIG. 3 is a diagram to describe various applications of objects and people applicable to the system and devices according to the example embodiments.

Referring to FIGS. 1-3, there is shown an example paired object relationship (wallet to keys) in which a user has affixed asset of paired electronic devices to two objects: a local electronic device 10A to his wallet and a second electronic device 10B to keys. In this example, a separation distance parameter threshold has been set in a microprocessor of both devices 10A, 10B. In an example, this may be in a range of 10-25 feet; in this example it has been set at 15 feet for explanatory purposes only.

Upon breach of the separation distance parameter threshold, a trigger condition is met. In this basic example, a loud audible alarm is activated (high decibel “beep beep” 15). This can be accompanied by a high-intensity blinking or steady LED light (shown for illustrative purposes only by the red light on devices 10A/10B). When the keys are back in the possession of the user (such as within a reset distance from the wallet), this satisfies being reconnected; the triggering condition deactivates.

In FIG. 2, each electronic device 10A/B has a front surface 11, rear surface 12; attachment means 13 and an LED 14. The devices 10A/B shown herein is not shown to scale or as an exact form-factor. The electronic devices 10A/B may takes the form of a tag, element, and form factor of a card, flash drive/memory stick, etc., and may be constructed of a hard plastic casing. Although the attachment means 13 is shown as a clasp, it may be embodied as hook and loop, Velcro, 3M dura-lock, adhesive, and interference fit, tongue and groove, snap-fit, etc.

The rear surface 12 may include indicia 16 thereon. The indicia may include website information and serial number information of the device 10A/B. Alternatively, one or more serial numbers, addresses or MAC addresses may be included thereon that identify one or more of the electronic device 10A/B or object to which the device 10A/B is attached to, which may be accessible at the website to discern the user/owner thereof.

As shown in FIG. 3, the example embodiments are directed to maintaining paired objects connected, such as parent-child, pet-owner, cell-phone-handbag, wallet, keys, as well as helping to any other object which may from time to time need to be located by its owner or caregiver.

Each locator device may include a transceiver and antenna that is configured with a Bluetooth radio standard and communication protocol interface and circuitry for internet communications with a website application. The Bluetooth standard has gained popularity for its range of applications as transceiver microchips can presently be designed for low-cost and low power consumption.

Moreover, software advancements specifically designed for low power applications, for example Zigbee®, has prompted consumer electronic solutions refocusing on cost effective wider availability. Accordingly, each electronic device may be configured with future developed ZigBee Telecom Services® certified products developed by companies of the Zigbee Alliance® by simplifying the process of locating missing objects and/or providing the interface to the website application by providing a gateway to the internet service provider hosting the website, for example.

Accordingly, device electronics includes a microprocessor that controls overall operation thereof according to programming stored in memory, which can be SRAM memory. Electronics may include inputs, which may provide for activation of pre-designated functionality controlled by microprocessor, such as pre-recorded, customized messages issued to the electronic device from a remote website application. The electronic device includes an LED as warning light when the separation distance threshold has been violated. Although some initial programming (e.g., separation distance threshold) may be stored or set in the memory at time of manufacture, additional, new or modified programming may be transmitted wirelessly thereto via the transceiver received by its antenna.

An audible alarm may also be included in the electronic device and controlled by the microprocessor. The alarm can be activated to provide a high-decibel, audible noise to warn the owner that the person/object being monitored has violated the separation distance threshold.

Power to the microprocessor and other electronic components is provided by an internal battery (rechargeable lithium-ion or Ni—Cd or replaceable lead acid for example) and internal to the housing and not accessible by the person/object being monitored.

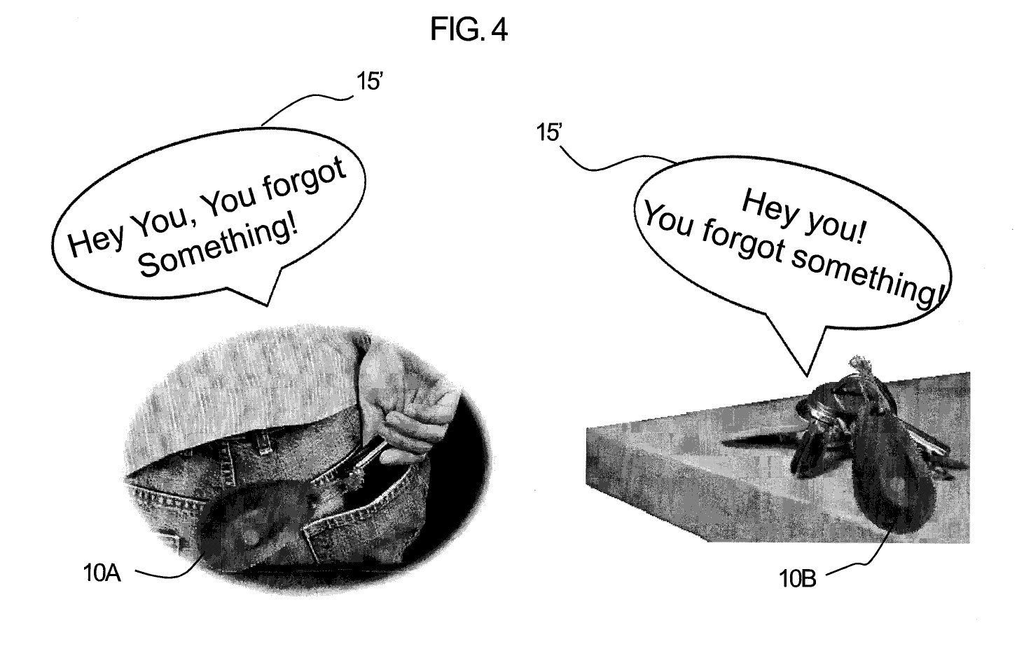

FIG. 4 is a diagram of an example customized message emitted between paired electronic devices upon violation of a separation distance parameter according to an example embodiment. FIG. 4 is similar to FIG. 1, except here the user has pre-recorded a customized message either at the website application or central unit that has been transmitted to the microprocessors on the electronic units 10A/10B via the antenna and transceiver circuitry.

Thus, upon breach of the separation distance parameter threshold, the trigger condition is met such that the audio voice message “Hey you! You forgot something!” is simultaneously emitted on devices 10A/10B. When the keys are back in the possession of the user (such as within a reset distance from the wallet), this satisfies being reconnected; the triggering condition deactivates.

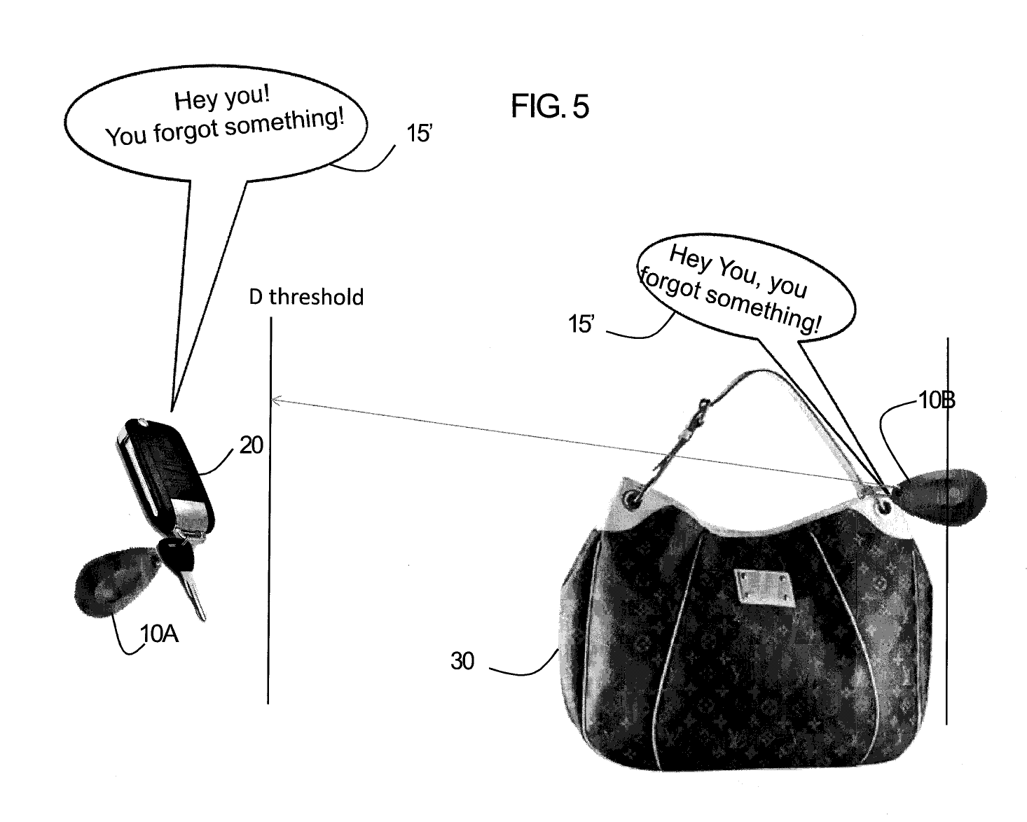

FIG. 5 is a diagram of the example customized message of FIG. 4 emitted between paired electronic devices upon violation of a separation distance parameter between different objects. Here, a visual distance threshold D is shown between keys 20 and a handbag 30 that is with the user (not shown). The keys 20 are shown exceeding the separation distance parameter threshold D, prompting the triggering condition and customized voice recording created by the user. Concurrently, the LED light could also be activated.

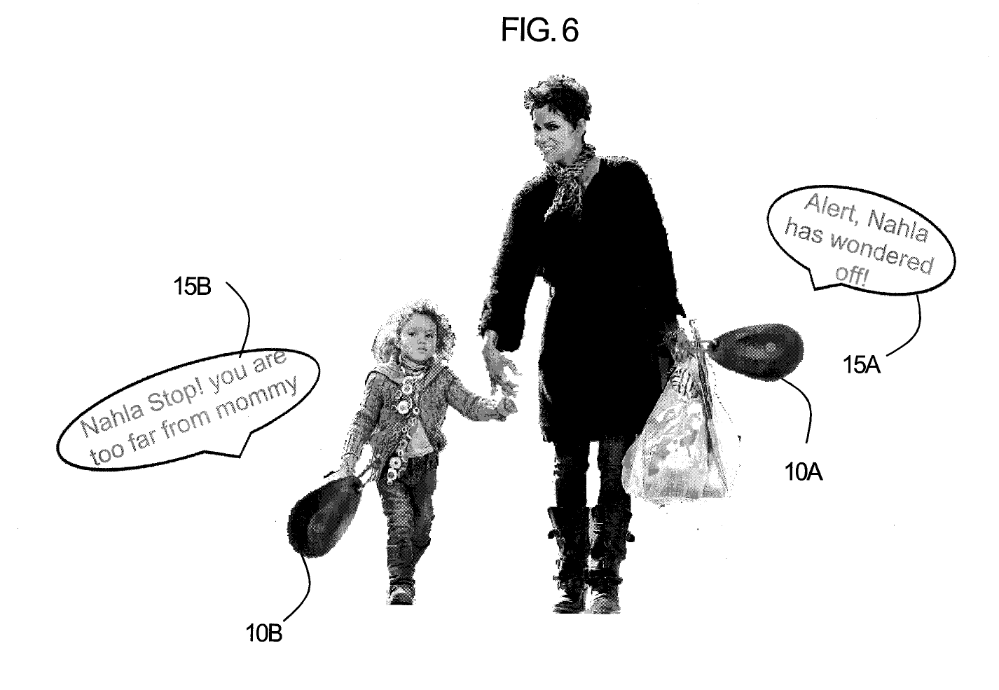

FIG. 6 is a diagram of another example customized message emitted between paired electronic devices upon violation of a separation distance parameter according to an example embodiment. Here, a parent-child paring is shown, where the user has pre-recorded two different customized voice messages for electronic devices 10A and 10B. Message 15B indicates what message would emit on device 10B if the child exceeded the separation distance parameter threshold from the adult, prompting the triggering condition and the two distinctly different customized voice recordings created by the user. Concurrently, the LED light could also be activated.

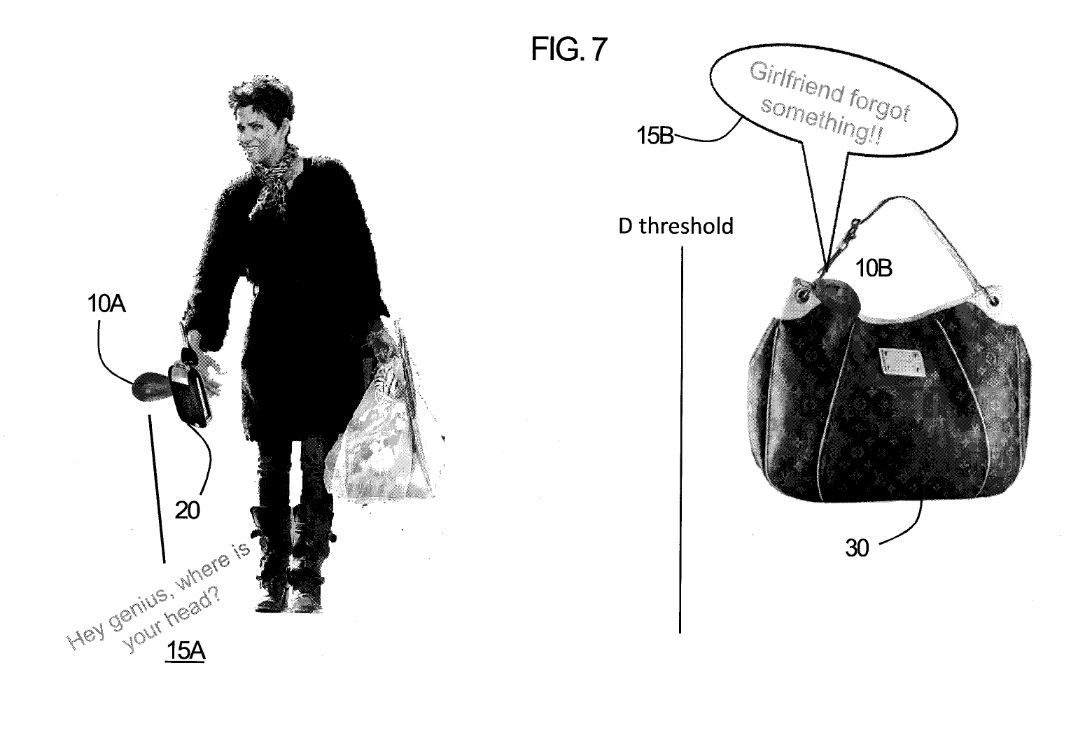

FIG. 7 is a diagram of another example customized message emitted between paired electronic devices upon violation of a separation distance parameter according to an example embodiment. Here, a visual distance threshold D is shown between keys 20 and a handbag 30 that is with the user (not shown). The handbag 30 is shown exceeding the separation distance parameter threshold D, prompting the triggering condition and two distinctly different customized voice recordings 15A, 15B created by the user. Concurrently, the LED light could also be activated.

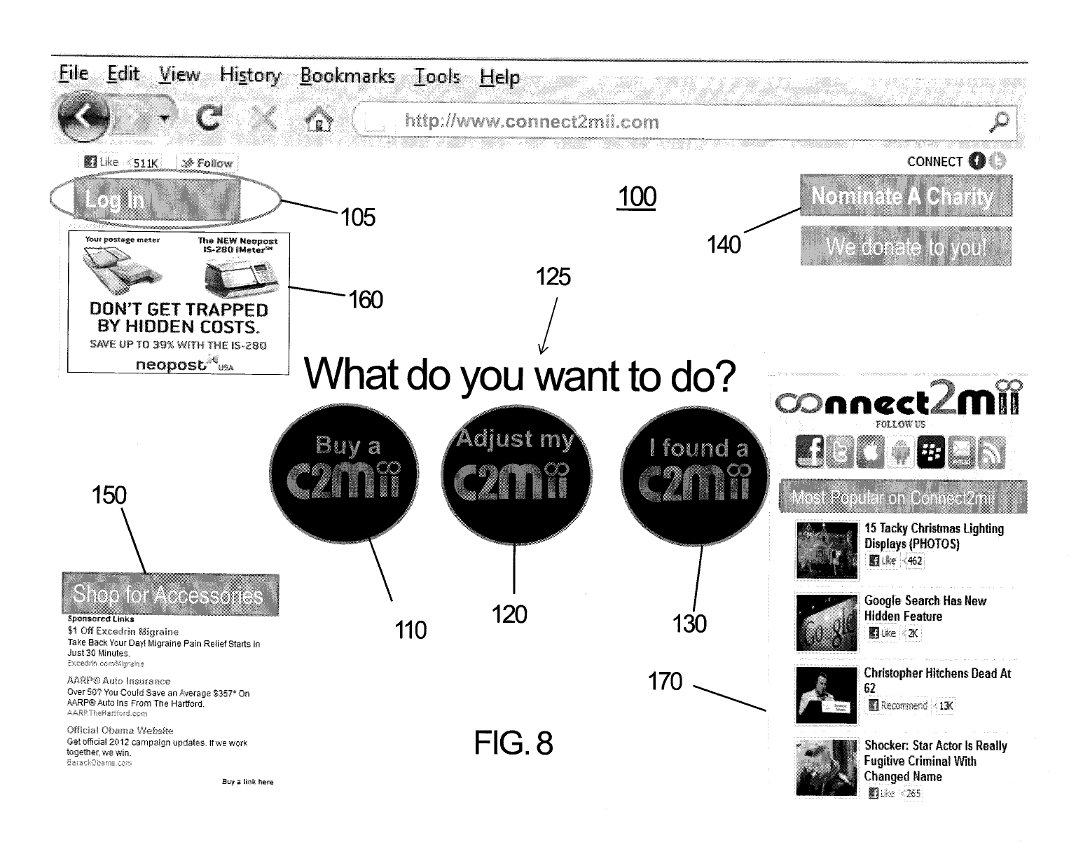

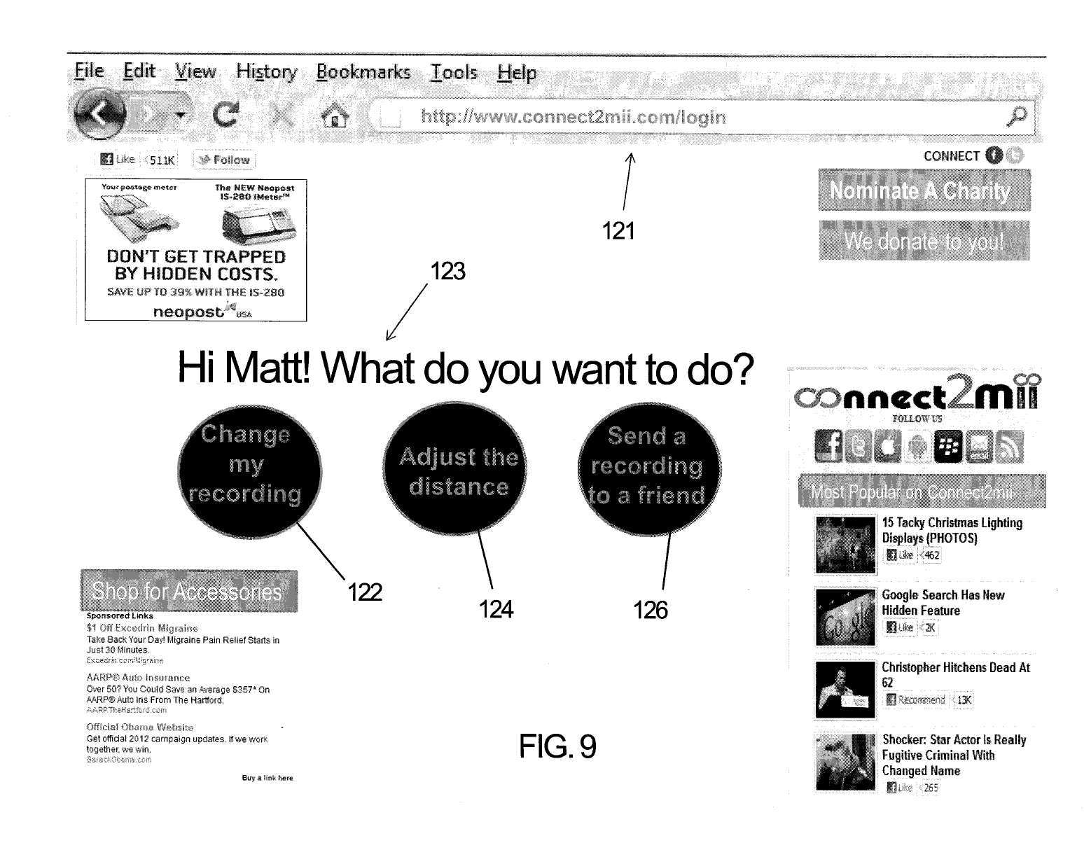

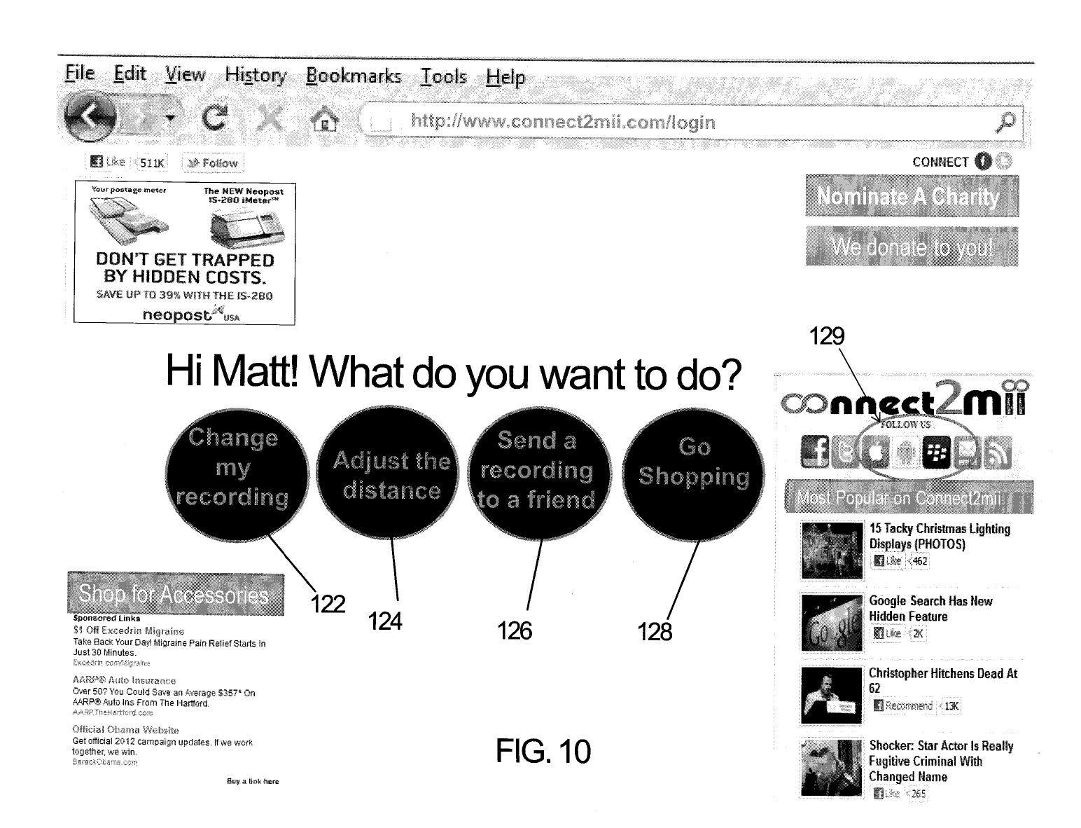

FIG. 8 is an example screenshot of a website application accessible by a user or potential user of the system; FIG. 9 is an example screenshot of a webpage of the application upon login by a user; and FIG. 10 is another example screenshot of a webpage of the application upon login by a user.

Referring to FIGS. 8-10, a screenshot 100 of a web application prompts the user for a login at cell 105. In FIG. 8, the user may enter their login information with a prompt of “What do you want to do?” and select to buy a subscription (icon 110), adjust their settings (icon 120) or report that they found a device (icon 130). If a person is not a member, they can click on icon 130 and enter the serial number of the device and the owner/user will be contacted and put in touch with the finder; i.e., no login is required.

Additionally the web application permits a user to nominate a charity (cell 140), to shop (cell 150) and displays advertisements at 160. There is also a displayed scroll 170 of most popular links 170. As shown in FIG. 9, if the user selects to adjust settings at icon 120, they have logged in (see 121) and are taken to another page where they are prompted by their name (at 123) to change their recording (icon 122), adjust the separation distance parameter threshold (icon 124) or send a recording to a friend (icon 126). As shown in FIG. 10, there may be an option shopping icon 128. Additionally, there is a bar 129 to follow the website on various social media and the link or synchronize with various smart phones.

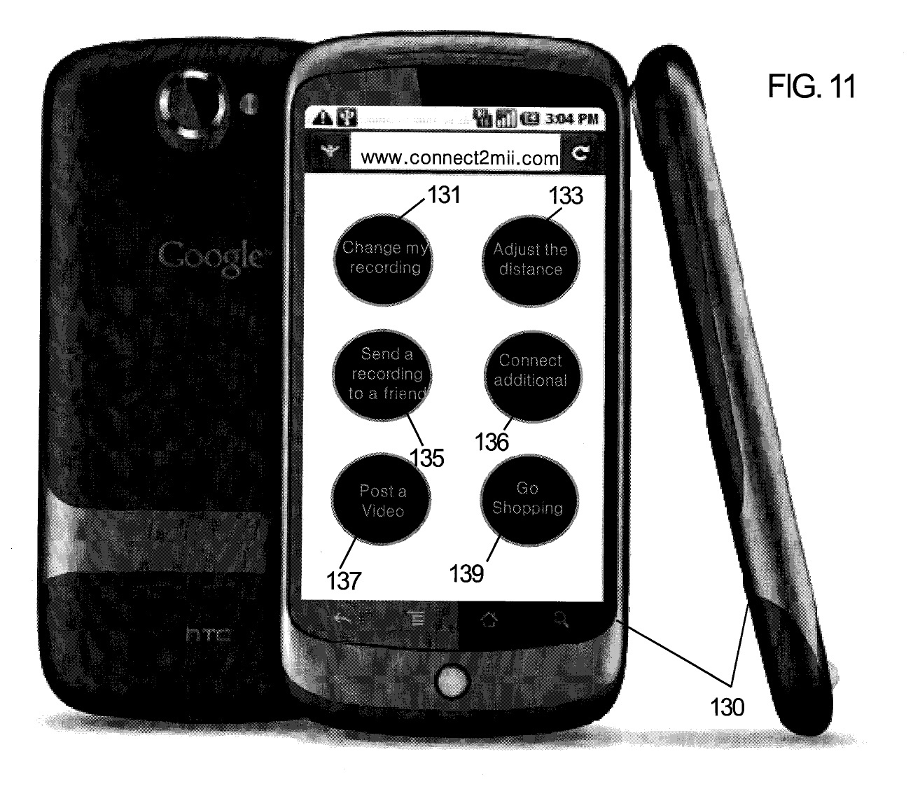

FIG. 11 is a smart phone with displayed application thereon which interfaces with the system for access by a user, according to an example embodiment. Heretofore it has been described where users may customize their electronic devices by accessing the internet via their computer, or via a central unit, sending information remotely (wirelessly) to a microprocessor on the device, via transceiver and associated antenna, to reconfigure the electronic device(s) to the user's needs. FIG. 11 illustrates where the electronic device(s) 10A/B may be updated or reconfigured via a remote mobile device such as a cell phone or tablet. In FIG. 11, there is shown a cell phone 130 configured with an application similar to as shown in FIGS. 8-10. In particular, the user has access to functions including: change their recording (icon 131), adjust the separation distance parameter threshold (icon 133), send a recording to a friend (icon 135), connect additional devices (icon 136), post a video (icon 137) and a shopping icon 139.

Once any new or modified recordings are made, distance parameters changed, or devices are to be added, the updated programming commands are transmitted wirelessly thereto via the transceivers of the devices, received by the corresponding antennas thereof and downloaded into respective microprocessors.

The example embodiments being thus described, it will be obvious that the same may be varied in many ways. Such variations are not to be regarded as departure from the example embodiments, and all such modifications as would be obvious to one skilled in the art are intended to be included herein.

I claim:

1. A system configured to maintain physical objects connected to one other, comprising,
a first electronic devices and a second electronic device configured as a set, a separation parameter distance threshold being set in each of the paired electronic devices,
a pair of first and second objects of a user that are to be maintained substantially connected thereto, the first and second electronic devices affixed to the corresponding first and second objects.
an audio message being emitted from each paired device of the set if the separation parameter distance threshold is exceeded, the audio message deactivated upon a separation distance between the objects having decreased below a set reset parameter,
the audio message customizable by the user and configured to be modified from a remote location.

2. The system of claim 1, wherein each electronic device includes a microprocessor that triggers one or more of an audible alarm, a flashing light and a customized recorded, audible message to notify the user that the objects are no longer connected.

3. The system of claim 1, wherein the audio message is a pre-recorded customized message made by in the user's voice.

4. The system of claim 1, wherein the user modifies the recorded message stored in one or both of the electronic devices remotely from a smart phone.

5. The system of claim 1, wherein the user modifies the separation distance parameter threshold stored in one or both of the electronic devices remotely from a smart phone.

6. The system of claim 1, wherein the user shares a recorded message being used with a third party and adds another electronic device to monitor remotely from a smart phone.
